(19) United States
(12) Patent Application Publication
(10) Pub. No.: US 2026/0365520 A1
(43) Pub. Date: Nov. 19, 2026

(54) A METHOD TO OBTAIN PURE GRAPHITE FROM LEACH RESIDUE OF SPENT LITHIUM-ION BATTERIES

(71) Applicant: ATTERO RECYCLING PVT. LTD., Roorkee, OT (IN)

(72) Inventors: Nitin GUPTA, Roorkee (IN); Bhuvnesh KUMAR, Roorkee (IN); Manoj JOSHI, Roorkee (IN); G. PRABAHARAN, Roorkee (IN); Smruti Prakash BARIK, Roorkee (IN)

(21) Appl. No.: 19/121,144

(22) PCT Filed: Oct. 13, 2023
(86) PCT No.: PCT/IB2023/060341

§ 371 Date: Apr. 15, 2025

(30) Foreign Application Priority Data
Oct. 15, 2022 (IN) 202211059004

(51) Int. Cl. C01B 32/215; H01M 10/54

(52) U.S. Cl. CPC C01B 32/215; H01M 10/54

(57) ABSTRACT

With the wide usage of Li-ion batteries (LIBs), recycling and reusing LIBs have attracted wide attention. However, due to the low added value and rigorous separation steps, recycling and recovering graphite anode materials are discarded. Although some direct physical recycling processes have been reported, all of them are limited by rigorous separation steps and lab scales. The present invention relates to a method for recovering highly pure graphite from leach residue of spent lithium ion batteries. The process is simple, easy and provides 99.9% pure graphite. Additionally, the method for recovering highly pure graphite is clean, green, environment friendly and commercially feasible.

### FIELD OF THE INVENTION

The present invention relates to the recovery of graphite from spent lithium-ion batteries. More particularly, the present invention relates to a method for recovery of graphite from leach residue of spent lithium-ion batteries that is environmentally friendly, commercially feasible and economically attractive.

### BACKGROUND OF THE INVENTION

From the initial discovery in the 1970's through the awarding of the Nobel Prize in 2019, the use of lithium-ion batteries (LIBs) has increased exponentially. As the world has grown to depend on the power and convenience brought by LIBs, the manufacturing and disposal of the LIBs have increasingly become subjects of political and environmental concerns.

Due to the complex structure and number of materials in lithium-ion batteries, the batteries must be subjected to a variety of processes prior to reuse/recycling. LIBs must be first classified and most often pre-treated through discharge or inactivation, disassembly, and separation after which the LIBs can be subjected to direct recycling, pyrometallurgy, hydrometallurgy, or a combination of methods.

Graphite is currently the state-of-the-art anode material for commercial lithium-ion batteries owing to its high reversible capacity and good cycling stability. Spent graphite anode, accounting for 12-21 wt. % of batteries, contains metals, binders, toxic, and flammable electrolytes. The efficient recovery of spent graphite is urgently needed for environmental protection and resource sustainability. Several recovery and treatment approaches, such as deep purification, selective lithium extraction, and residual electrolyte removal, and the limits of said processes are described. The diversified resource recycling paths of recycled graphite and its products are summarized on the basis of different graphite structural characteristics, including its role as anode material or raw material for catalysts, graphene and composite films.

CN111072023B discloses the method for recovering graphite from scrapped lithium ion battery. Alkaline leaching and acid leaching is carried out on mechanically crushed lithium ion total battery waste to obtain a graphite crude product and a filtrate containing Co, Fe, Ni and Mn metals. The method is simple in process and low in cost and energy consumption, and the recycled graphite has excellent stability. Roasting is done at 500 °C to obtain graphite residue.

CN112320794 A discloses a deep impurity removal method for recovering and cyclically regenerating graphite in a retired battery. An eutectic compound is formed through alkali compounding. Impurity elements that are usually difficult to remove completely in retired graphite are thoroughly removed at a low temperature and the graphite subjected to impurity removal and regeneration meet the physicochemical properties of battery-grade graphite and has good electrochemical properties. The process involved is lengthy and requires use of multiple chemicals.

WO2021252433 A9 discloses a method for recycling anode materials from a comingled recycling stream derived from exhausted lithium ion batteries. A strong acid is added to the precipitate for removal of residual cathode and separator materials. The strong acid removes residual aluminium oxide from the separator by transformation to aluminium sulphate. Washing the acid treated precipitate removes water soluble contaminants, such as the aluminium sulphate obtained from the aluminium oxide and sulphuric acid, to generate substantially pure graphite. The method involved is lengthy, costly and difficult to commercialize due to corrosion.

Hien Tran et. Al., (World Journal of Research and Review (WJRR) ISSN: 2455-3956, Volume-5, Issue-1, July 2017 Pages 23-26) in 2017, discloses a technology to increase the purity of the graphite carbon from 92.6% to 98%. Study was conducted on leaching agents, concentration of sulphuric acid, temperature, time, and liquid/solid ratio affecting the process. The results showed that graphite content can be increased from 92.6% to 98% that meets the requirement for high purity graphite. However, roasting was done with alkali.

Yatim Lailum Ni'mah et. Al., (Ni'mah & al./Mor. J. Chem. 10 No 3) in 2022, presented an approach for separation of graphite by mechanical method to remove plastic components. The graphite obtained was washed using dimethyl carbonate (DMC) and N-methyl-20pyrrolidone (NMP) and leached in H₂SO₄. The residue obtained was heated in furnace at 500 °C for 1 hour using N₂ atmosphere. FTIR and XRD characterizations were carried out to compare anode materials obtained by mechanical process only by leaching process.

Yue Yang et. al., (Waste Management 85 (2019) 529-537) in 2019, discloses recycling lithium and graphite from spent lithium ion battery. Spent graphite was firstly collected by a two-stage calcination, under the optimal conditions of 1.5 M HCl, 60 min, and solid-liquid ratio (S/L) of 100 gL⁻¹, the collected graphite suffers simple acid leaching to make almost 100% lithium, copper and aluminium into leach liquor. 99.9% aluminium and 99.9% copper were removed from leach liquor by adjusting pH and then, the lithium was recovered by adding sodium carbonate in leach liquor to form lithium carbonate with high purity (>99%). The regenerated graphite is found to have high initial specific capacity at the rate of 37.2 mA·g⁻¹ (591 mAh·g⁻¹), 74.4 mA·g⁻¹ (510 mAh·g⁻¹) and 186 mA·g⁻¹ (335 mAh·g⁻¹) and with the high retention ratio of 97.9% after 100 cycles. The process involves double roasting followed by HCl and H₂O₂ treatment.

Yang Gao et. al., (ACS Sustainable Chem. Eng., DOI: 10.1021/acssuschemeng.0c02321) in 2021, discloses a novel method to regenerate spent graphite via combined sulphuric acid curing, leaching and calcination process. A sulphuric acid curing-acid leaching experiment was conducted and the effects of various operation conditions on the removal of aluminium were studied. The purity of regenerated graphite reaches 99.6% and the regenerated graphite exhibits good electrochemical performance in charge capacity and cycle. Regenerated graphite was obtained after a sequential calcination at 1500 °C, and its morphology and structure were characterized by using XRD, Raman spectroscopy and SAEM analysis. The processing time is 24 hours.

Over the past few years, more and more studies have been focused on spent graphite recycling, while the challenges are rarely summarized. The reported state of the art technologies includes lengthy process, high temperatures, use of multiple chemicals along with environmental issues.

Therefore, there is a need for an approach that addresses the problem of existing state of the art and provides a process that is clean, green, environmentally friendly and commercially feasible. The method disclosed in the present invention is specific for graphite removal with high purity. The method is highly useful as it reduces the lengthy processes and is commercially feasible.

### OBJECT OF THE INVENTION

The main object of the present invention is to provide a method for recovery of pure graphite from leach residue of spent lithium ion batteries.

Another object of the present invention is to provide a method for recovery of pure graphite with 99.9% purity that gives value addition to the product.

Yet another object of the invention is to provide a process that is less time consuming.

Yet another object of the present invention is to provide a method that is commercially feasible and economically attractive.

Still another object of the present invention is to provide a method which is simple, clean, green and environment friendly.

### SUMMARY OF THE INVENTION

The present invention relates to a method of recovery of graphite from leach residue of spent lithium-ion batteries. The present invention provides an environment friendly and commercially feasible process for recovery of highly pure graphite.

In an embodiment, the present invention provides a method for recovery of graphite from spent lithium ion batteries comprising of the steps of, leaching black mass of spent lithium-ion batteries to obtain leach residue and mixing the leach residue of spent lithium ion batteries with a suitable solvent and water and keeping the mixture at a predetermined temperature for a pre-defined time to obtain a pugged residue. The pugged residue is cooled at room temperature. The residue obtained is agitated with a suitable reagent at a pre-defined solid-liquid ratio for a pre-defined time to obtain a slurry. The slurry obtained is filtered, washed and dried to obtain pure graphite.

The process to get pure graphite of 99.9% purity is simple, easy and gives value addition to the product. The method is clean, green, environmentally friendly, commercially feasible and economically attractive.

The above objects and advantages of the present invention will become apparent from the hereinafter set forth brief description of the drawings, detailed description of the invention, and claims appended herewith.

### BRIEF DESCRIPTION OF THE DRAWINGS

An understanding of the method of recovery of graphite from leach residue of the spent lithium-ion batteries of the present invention may be obtained by reference to the following drawing:

FIG. 1 is a process flow chart to get pure graphite from spent lithium ion battery leach residue, according to an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

The present invention now will be described hereinafter with reference to the detailed description, in which some, but not all embodiments of the invention are indicated. Indeed, the invention may be embodied in many different forms and should not be construed as limited to the embodiments set forth herein; rather, these embodiments are provided so that this disclosure will satisfy applicable legal requirements. Like numbers refer to like elements throughout. The present invention is described fully herein with non-limiting embodiments and exemplary experimentation.

The present invention relates to a method of recovery of graphite from leach residue of spent lithium-ion batteries. The present invention provides an environment friendly and commercially feasible process for recovery of highly pure graphite.

In a preferred embodiment, the present invention provides a method for recovery of pure graphite from spent lithium ion batteries comprising the steps of: (a) leaching black mass of spent lithium-ion batteries to obtain a leach residue; (b) mixing the leach residue of the spent lithium ion batteries obtained in step (a) with a suitable solvent and 20-30% water to obtain a mixture; (c) keeping the mixture obtained in step (b) at a predetermined temperature for a pre-defined time to obtain a pugged residue; (d) cooling the pugged residue obtained in step (c) at room temperature; (e) agitating the cooled residue obtained in step (d) with a suitable reagent at a pre-defined solid-liquid ratio for a pre-defined time to obtain a slurry; and (f) filtering the slurry obtained in step (e) to obtain a residue followed by washing with water and drying the residue to get pure graphite.

Here, the leach residue of step (a) is obtained by leaching the black mass of spent lithium-ion batteries on a running plant. The suitable solvent of step (b) is 15-20% sulphuric acid (98% (w/w)) and the predetermined temperature of step (c) is in a range of 200-300 °C and the pre-defined time of step (c) is 2-4 hours.

Further, the suitable reagent in step (e) is 10-20% (v/v) sulphuric acid and the pre-defined time of step (e) is in a range of 2-4 hours. The solid-liquid ratio of step (e) is 1:2.

The process to get pure graphite of 99.9-99.95% purity is simple and easy that gives value addition to the product. The method is clean, green, environmentally friendly and commercially feasible, and economically attractive.

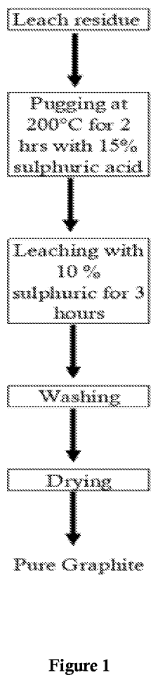

FIG. 1 illustrates the process flow to get pure graphite from spent lithium ion battery leach residue. The process is simple and easy and aids in recovering 99.9% pure graphite.

The invention will now be illustrated by the following non-limiting examples.

### Example 1

### Batch Analysis

### Batch 1:

10 kg of leach residue of spent lithium-ion batteries from the plant was taken and mixed with 150 mL of sulphuric acid and 200 ml of water. The mixture was then kept at 200 °C in a muffle furnace for 3 hours and then kept outside for cooling. The pugged material was taken in a plastic vessel with 20 liters of water and 2 liters of sulphuric acid was added under agitation. The agitation continued for 3 hours and the slurry was filtered and the final residue was washed with 13 liters of water and dried. The analysis of dried residue-2 (pure graphite-9.95 kg), leach residue of plant, and the filtrate (30 L) are presented in the tables below.

TABLE 1
Analysis of leach residue

| Element | Fe | Cu | Ni | Co | Mn | Li | Al |
|---|---|---|---|---|---|---|---|
| % | 0.57 | 1.27 | 0.36 | 0.44 | 0.04 | 0.15 | 0.33 |

TABLE 2
Analysis of filtrate

| Element | Fe | Cu | Ni | Co | Mn | Li | Al |
|---|---|---|---|---|---|---|---|
| g/L | 1.9 | 4.1 | 1.1 | 1.45 | 0.13 | 0.5 | 1.1 |

TABLE 3
Analysis of purified graphite (99.95%)

| Element | Fe | Cu | Ni | Co | Mn | Li | Al |
|---|---|---|---|---|---|---|---|
| % | 0.001 | 0.05 | 0.001 | 0.001 | 0.001 | 0.001 | 0.001 |

### Batch 2:

10 kg of leach residue of spent lithium-ion batteries from the plant was taken and mixed with 150 mL of sulphuric acid and 200 ml of water. The residue was kept at 200 °C in a muffle furnace for 3 hours and then kept outside for cooling. The pugged material was taken in a plastic vessel with 20 liters of water and 1 liter of sulphuric acid was added under agitation. The agitation continued for 3 hours and the slurry was filtered and the final residue was washed with 13 liters of water and dried. The analysis of dried residue-2 (pure graphite-9.96 kg), leach residue of plant, and the filtrate (30 L) are presented in the tables below.

TABLE 1
Analysis of leach residue

| Element | Fe | Cu | Ni | Co | Mn | Li | Al |
|---|---|---|---|---|---|---|---|
| % | 0.57 | 1.27 | 0.36 | 0.44 | 0.04 | 0.15 | 0.33 |

TABLE 2
Analysis of filtrate

| Element | Fe | Cu | Ni | Co | Mn | Li | Al |
|---|---|---|---|---|---|---|---|
| g/L | 1.95 | 4.15 | 1.1 | 1.45 | 0.14 | 0.5 | 1.2 |

TABLE 3
Analysis of purified graphite (99.96%)

| Element | Fe | Cu | Ni | Co | Mn | Li | Al |
|---|---|---|---|---|---|---|---|
| % | 0.001 | 0.04 | 0.001 | 0.001 | 0.001 | 0.001 | 0.001 |

The graphite obtained from leach residue of spent lithium-ion batteries is 99.9% pure.

Therefore, the present invention provides a simple, clean, easy to approach, environmentally friendly and commercially feasible method to get pure graphite from spent lithium ion batteries. The process to obtain graphite of 99.9% purity gives value addition to the product.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A method for recovery of graphite from spent lithium ion batteries, characterized in that, the method comprises the steps of:
(a) leaching black mass of spent lithium-ion batteries to obtain a leach residue;
(b) mixing the leach residue of the spent lithium ion batteries obtained in step (a) with a suitable solvent and 20-30% water to obtain a mixture;
(c) keeping the mixture obtained in step (b) at a predetermined temperature for a pre-defined time to obtain a pugged residue;
(d) cooling the pugged residue obtained in step (c) at room temperature;
(e) agitating the cooled residue obtained in step (d) with a suitable reagent at a predetermined solid-liquid ratio for a pre-defined time to obtain a slurry; and
(f) filtering the slurry obtained in step (e) to obtain a residue followed by washing with water and drying the residue to get pure graphite.

2. The method for recovery of graphite from spent lithium ion batteries, wherein the leach residue of step (a) is obtained by leaching the black mass of spent lithium-ion batteries on a running plant.

3. The method for recovery of graphite from spent lithium ion batteries, wherein the suitable solvent of step (b) is 15-20% sulphuric acid (98% (w/w).

4. The method for recovery of graphite from spent lithium ion batteries, wherein the predetermined temperature of step (c) is in a range of 200-300 °C and the pre-defined time of step (c) is 2-4 hours.

5. The method for recovery of graphite from spent lithium ion batteries, wherein the suitable reagent of step (e) is 10-20% (v/v) sulphuric acid and the pre-defined time of step (e) is in a range of 2-4 hours.

6. The method for recovery of graphite from spent lithium ion batteries, wherein the pre-defined solid-liquid ratio of step (e) is 1:2.

7. The method for recovery of graphite from spent lithium ion batteries, wherein the graphite obtained in step (f) is 99.9-99-95% pure.
